(19) United States
(12) Patent Application Publication
(10) Pub. No.: US 2013/0321120 A1
(43) Pub. Date: Dec. 5, 2013

(54) Thermostat

(71) Applicant: Art-Sea Industrial Company Limited, Hong Kong (HK)

(72) Inventor: Pan Hoi LAU, Hong Kong (HK)

(73) Assignee: Art-Sea Industrial Company Limited, Hong Kong (HK)

(21) Appl. No.: 13/901,558

(22) Filed: May 23, 2013

Related U.S. Application Data
(60) Provisional application No. 61/653,418, filed on May 31, 2012.

(51) Int. Cl. H01H 37/72

(52) U.S. Cl. CPC H01H 37/72
USPC 337/360; 337/333

(57) ABSTRACT

A thermostat includes a heat-conductive guide with an upper side and a lower side; a top board with an upper side and a lower side; a double-metal plate; a first rivet; a short spring plate with a first electrical contact disposed thereon; a long spring plate being connected with the short spring plate; a contact board with a second electrical contact disposed thereon; and a second rivet. The upper side of the heat-conductive guide is connected with the lower side of the top board through the first rivet. The lower side of the heat-conductive guide is connected with the double-metal plate through the first rivet. The long spring plate and the contact board are connected with the lower side of the top board through the second rivet. The double-metal plate is configured to sense a temperature of the heat-conductive guide and actuate the short spring plate accordingly.

### CROSS-REFERENCE TO RELATED APPLICATIONS

This application claims the benefit of U.S. Provisional Patent Application No. 61/653,418 filed on May 31, 2012, the contents of which is hereby incorporated by reference.

### FIELD OF THE PATENT APPLICATION

The present patent application generally relates to temperature control technologies and more specifically to a thermostat that can be used as a temperature control device in home appliances such as an electronic toaster.

### BACKGROUND

A conventional thermostat usually uses a guide to conduct heat, and a push pole to pull up a control arm so as to push up a long spring plate and a short spring plate and to break up an upper silver point and a lower silver point. The conventional thermostat, however, has challenges in terms of the production yield rate, the manufacturing cost and the manufacturing safety.

### SUMMARY

The present patent application is directed to a thermostat. In one aspect, the thermostat includes a heat-conductive guide with an upper side and a lower side; a top board with an upper side and a lower side; a double-metal plate; a first rivet; a short spring plate with a first electrical contact disposed thereon; a long spring plate being connected with the short spring plate; a contact board with a second electrical contact disposed thereon; and a second rivet.

The upper side of the heat-conductive guide is connected with the lower side of the top board through the first rivet. The lower side of the heat-conductive guide is connected with the double-metal plate through the first rivet. The long spring plate and the contact board are connected with the lower side of the top board through the second rivet. The double-metal plate is configured to sense a temperature of the heat-conductive guide and actuate the short spring plate accordingly so that the first electrical contact is physically and electrically connected with the second electrical contact when the temperature sensed reaches a target temperature.

The thermostat may further include a temperature adjusting screw, a washer, and a control shaft sequentially from up to down installed on the upper side of the top board. The temperature adjusting screw may be configured to adjust and set the target temperature. The washer may be engaged with the temperature adjusting screw, and configured to fix the setting of the target temperature.

The thermostat may further include a first ceramic ring, a first lug, a second ceramic ring, a second lug, a third ceramic ring, and a ceramic guide. The first ceramic ring, the first lug, the long spring plate, the second ceramic ring, the contact board, the second lug, the third ceramic ring, and the ceramic guide may be connected to the lower side of the top board through the second rivet sequentially from up to down.

The thermostat may further include a first ceramic separator disposed between an assembly of the long spring plate and the short spring plate and the double-metal plate. The double-metal plate may be configured to actuate the short spring plate through the first ceramic separator. The thermostat may further include a second ceramic separator disposed between the top board and the short spring plate. The temperature adjusting screw may be configured to actuate the short spring plate through the second ceramic separator.

The first electrical contact and the second electrical contact may be silver point contacts. The control shaft may be configured to be controlled by the temperature adjusting screw and pull or release the second ceramic separator so that the assembly of the long spring plate and the short spring plate is pulled or released. When the short spring plate is released, the first electrical contact may be physically and electrically connected with the second electrical contact.

The first lug may be electrically connected with the second lug when the first electrical contact is physically and electrically connected with the second electrical contact. The first ceramic ring, the second ceramic ring, the third ceramic ring, and the ceramic guide may be configured to provide electrical insulation.

In another aspect, the thermostat includes: a heat-conductive guide with an upper side and a lower side; a top board with an upper side and a lower side; a double-metal plate; a first rivet; a short spring plate with a first electrical contact disposed thereon; a long spring plate being connected with the short spring plate; a contact board with a second electrical contact disposed thereon; a second rivet; a temperature adjusting screw; a washer; and a control shaft. The upper side of the heat-conductive guide is connected with the lower side of the top board through the first rivet; the lower side of the heat-conductive guide is connected with the double-metal plate through the first rivet; the long spring plate and the contact board are connected with the lower side of the top board through the second rivet; the temperature adjusting screw, the washer, and the control shaft are sequentially from up to down installed on the upper side of the top board; the first electrical contact and the second electrical contact are silver point contacts; and the double-metal plate is configured to sense a temperature of the heat-conductive guide and actuate the short spring plate accordingly so that the first electrical contact is physically and electrically connected with the second electrical contact when the temperature sensed reaches a target temperature.

The temperature adjusting screw may be configured to adjust and set the target temperature, and the washer may be engaged with the temperature adjusting screw and configured to fix the setting of the target temperature.

The thermostat may further include a first ceramic separator disposed between an assembly of the long spring plate and the short spring plate and the double-metal plate. The double-metal plate may be configured to actuate the short spring plate through the first ceramic separator. The thermostat may further include a second ceramic separator disposed between the top board and the short spring plate. The temperature adjusting screw may be configured to actuate the short spring plate through the second ceramic separator.

In yet another aspect, the thermostat includes: a heat-conductive guide with an upper side and a lower side; a top board with an upper side and a lower side; a double-metal plate; a first rivet; a short spring plate with a first electrical contact disposed thereon; a long spring plate being connected with the short spring plate; a contact board with a second electrical contact disposed thereon; a second rivet; a temperature adjusting screw; a washer; a control shaft; a first ceramic ring; a first lug; a second ceramic ring; a second lug; a third ceramic ring; and a ceramic guide. The upper side of the heat-conductive guide is connected with the lower side of the top board through the first rivet. The lower side of the heat-conductive guide is connected with the double-metal plate through the first rivet. The long spring plate and the contact board are connected with the lower side of the top board through the second rivet. The temperature adjusting screw, the washer, and the control shaft are sequentially from up to down installed on the upper side of the top board. The first ceramic ring, the first lug, the long spring plate, the second ceramic ring, the contact board, the second lug, the third ceramic ring, and the ceramic guide are connected to the lower side of the top board through the second rivet sequentially from up to down. The double-metal plate is configured to sense a temperature of the heat-conductive guide and actuate the short spring plate accordingly so that the first electrical contact is physically and electrically connected with the second electrical contact when the temperature sensed reaches a target temperature.

The thermostat may further include a first ceramic separator disposed between an assembly of the long spring plate and the short spring plate and the double-metal plate. The double-metal plate may be configured to actuate the short spring plate through the first ceramic separator.

The thermostat may further include a second ceramic separator disposed between the top board and the short spring plate. The temperature adjusting screw may be configured to actuate the short spring plate through the second ceramic separator.

The control shaft may be configured to be controlled by the temperature adjusting screw and pull or release the second ceramic separator so that the assembly of the long spring plate and the short spring plate is pulled or released. When the short spring plate is released, the first electrical contact may be physically and electrically connected with the second electrical contact.

### BRIEF DESCRIPTIONS OF THE DRAWINGS

FIG. 1 is a side view of a thermostat according to an embodiment of the present patent application.

FIG. 2 is a top view of a thermostat depicted in FIG. 1.

FIG. 3 is an exploded view of the thermostat depicted in FIG. 1.

### DETAILED DESCRIPTION

Reference will now be made in detail to a preferred embodiment of the thermostat disclosed in the present patent application, examples of which are also provided in the following description. Exemplary embodiments of the thermostat disclosed in the present patent application are described in detail, although it will be apparent to those skilled in the relevant art that some features that are not particularly important to an understanding of the thermostat may not be shown for the sake of clarity.

Furthermore, it should be understood that the thermostat disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

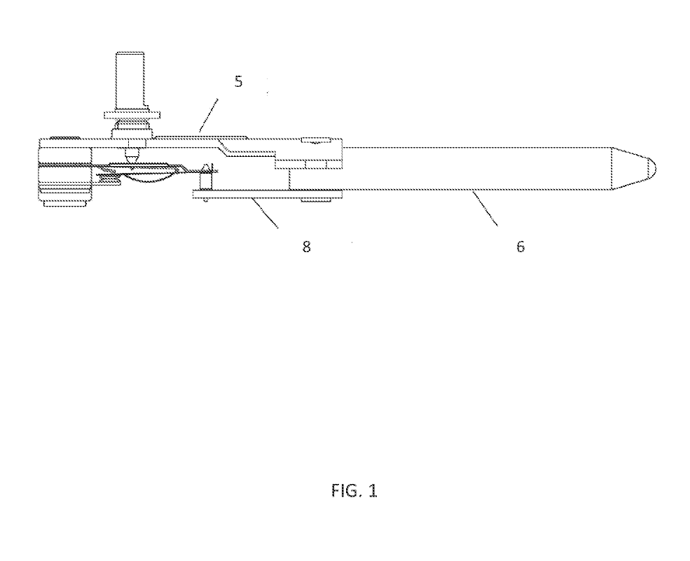

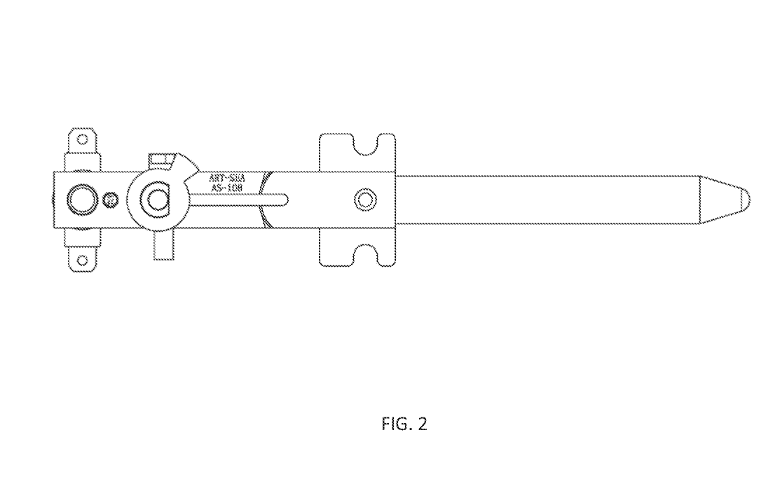

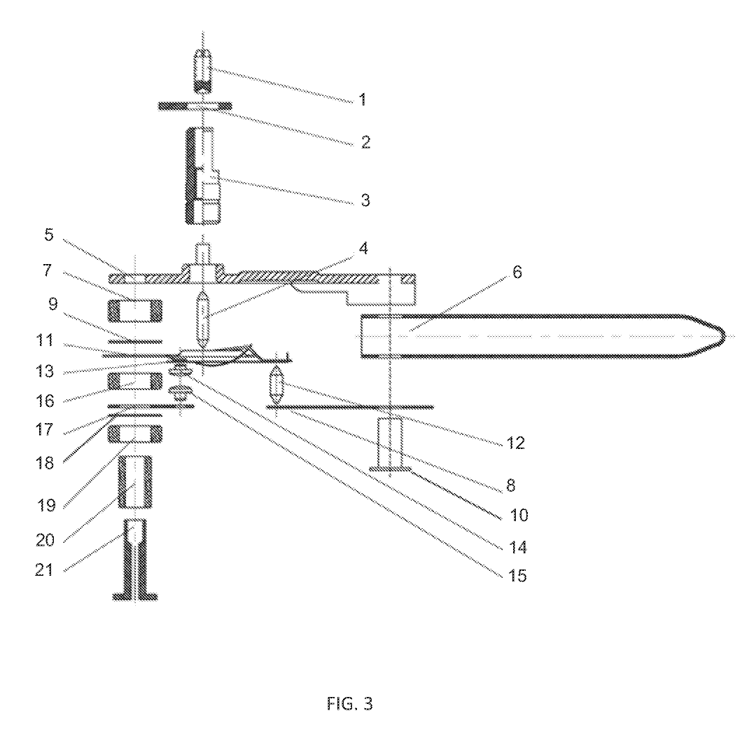

FIG. 1 is a side view of a thermostat according to an embodiment of the present patent application. FIG. 2 is a top view of a thermostat depicted in FIG. 1. FIG. 3 is an exploded view of the thermostat depicted in FIG. 1. The thermostat can be used as a temperature control device in home appliances such as an electronic toaster. As described hereafter in more detail, the thermostat includes a heat-conductive guide 6 with an upper side and a lower side, a top board 5 with an upper side and a lower side, a double-metal plate 8, a first rivet 10, a short spring plate 13 with a first electrical contact 14 disposed thereon, a long spring plate 11 being connected with the short spring plate 13, a contact board 17 with a second electrical contact 15 disposed thereon, and a second rivet 21. The upper side of the heat-conductive guide 6 is connected with the lower side of the top board 5 through the first rivet 10. The lower side of the heat-conductive guide 6 is connected with the double-metal plate 8 through the first rivet 10. The long spring plate 11 and the contact board 17 are connected with the lower side of the top board 5 through the second rivet 21. The double-metal plate 8 is configured to sense a temperature of the heat-conductive guide 6 and actuate the short spring plate 13 accordingly so that the first electrical contact 14 is physically and electrically connected with the second electrical contact 15 when the temperature being sensed reaches a target temperature.

More specifically, referring to FIGS. 1-3, the thermostat includes a heat-conductive guide 6. The heat-conductive guide 6 has an upper side and a lower side. The upper side of the heat-conductive guide 6 is connected with a lower side of a top board 5 through a first rivet 10. A temperature adjusting screw 1, a washer 2, and a control shaft 3 are sequentially from up to down installed on an upper side of the top board 5. The temperature adjusting screw 1 disposed above the top board 5 is configured to adjust and set the temperature that is required, i.e., the target temperature. The washer 2 is engaged with the temperature adjusting screw 1 and configured to fix the setting of the target temperature. A double-metal plate 8 is connected to the lower side of the heat-conductive guide 6 through the first rivet 10. A first ceramic ring 7, a first lug 9, a long spring plate 11, a second ceramic ring 16, a contact board 17, a second lug 18, a third ceramic ring 19, and a ceramic guide 20 are connected to the lower side of the top board 5 through a second rivet 21 sequentially from up to down. A short spring plate 13 is connected with the long spring plate 11. A first ceramic separator 12 is disposed between an assembly of the long spring plate 11 and the short spring plate 13 and the double-metal plate 8. The double-metal plate 8 is configured to actuate the short spring plate 13 through the first ceramic separator 12. A second ceramic separator 4 is disposed between the top board 5 and the short spring plate 13. The temperature adjusting screw 1 is configured to actuate the short spring plate 13 through the second ceramic separator 4. A first electrical contact 14 is disposed on the short spring plate 13. A second electrical contact 15 is disposed on the contact board 17. In this embodiment, the first electrical contact 14 and the second electrical contact 15 are silver point contacts. The control shaft 3 is configured to be controlled by the temperature adjusting screw 1 and pull or release the second ceramic separator 4 so that the assembly of the long spring plate 11 and the short spring plate 13 is pulled or released. When the short spring plate 13 is released, the first electrical contact 14 is physically and electrically connected with the second electrical contact 15, and thereby the first lug 9 is electrically connected with the second lug 18. The first ceramic ring 7, the second ceramic ring 16, the third ceramic ring 19, and the ceramic guide 20 are configured to provide electrical insulation.

In the above embodiment, the thermostat uses the first rivet 10 to fixedly connecting the double-metal plate 8 and the heat-conductive guide 6 without employing Argon gas and Nitrogen gas welding. In addition, the double-metal plate 8 in this embodiment is configured to directly implement the temperature control. As a result, compared with conventional thermostats, the assembly of the thermostat in this embodiment requires less human labor and energy so that the manufacturing cost is reduced. The temperature control realized by the thermostat is more stable, and the range of the temperature control can be customized based on specific user preferences. The production yield rate and the manufacturing safety of the thermostat are also improved.

While the present patent application has been shown and described with particular references to a number of embodiments thereof, it should be noted that various other changes or modifications may be made without departing from the scope of the present invention.

What is claimed is:

1. A thermostat comprising:
a heat-conductive guide with an upper side and a lower side;
a top board with an upper side and a lower side;
a double-metal plate;
a first rivet;
a short spring plate with a first electrical contact disposed thereon;
a long spring plate being connected with the short spring plate;
a contact board with a second electrical contact disposed thereon; and
a second rivet; wherein:
the upper side of the heat-conductive guide is connected with the lower side of the top board through the first rivet;
the lower side of the heat-conductive guide is connected with the double-metal plate through the first rivet;
the long spring plate and the contact board are connected with the lower side of the top board through the second rivet; and
the double-metal plate is configured to sense a temperature of the heat-conductive guide and actuate the short spring plate accordingly so that the first electrical contact is physically and electrically connected with the second electrical contact when the temperature sensed reaches a target temperature.

2. The thermostat of claim 1 further comprising a temperature adjusting screw, a washer, and a control shaft sequentially from up to down installed on the upper side of the top board.

3. The thermostat of claim 2, wherein the temperature adjusting screw is configured to adjust and set the target temperature.

4. The thermostat of claim 3, wherein the washer is engaged with the temperature adjusting screw, and configured to fix the setting of the target temperature.

5. The thermostat of claim 1 further comprising a first ceramic ring, a first lug, a second ceramic ring, a second lug, a third ceramic ring, and a ceramic guide, wherein the first ceramic ring, the first lug, the long spring plate, the second ceramic ring, the contact board, the second lug, the third ceramic ring, and the ceramic guide are connected to the lower side of the top board through the second rivet sequentially from up to down.

6. The thermostat of claim 2 further comprising a first ceramic separator disposed between an assembly of the long spring plate and the short spring plate and the double-metal plate, wherein the double-metal plate is configured to actuate the short spring plate through the first ceramic separator.

7. The thermostat of claim 6 further comprising a second ceramic separator disposed between the top board and the short spring plate, wherein the temperature adjusting screw is configured to actuate the short spring plate through the second ceramic separator.

8. The thermostat of claim 1, wherein the first electrical contact and the second electrical contact are silver point contacts.

9. The thermostat of claim 7, wherein the control shaft is configured to be controlled by the temperature adjusting screw and pull or release the second ceramic separator so that the assembly of the long spring plate and the short spring plate is pulled or released.

10. The thermostat of claim 9, wherein when the short spring plate is released, the first electrical contact is physically and electrically connected with the second electrical contact.

11. The thermostat of claim 5, wherein the first lug is electrically connected with the second lug when the first electrical contact is physically and electrically connected with the second electrical contact.

12. The thermostat of claim 5, wherein the first ceramic ring, the second ceramic ring, the third ceramic ring, and the ceramic guide are configured to provide electrical insulation.

13. A thermostat comprising:
a heat-conductive guide with an upper side and a lower side; a top board with an upper side and a lower side; a double-metal plate; a first rivet; a short spring plate with a first electrical contact disposed thereon; a long spring plate being connected with the short spring plate; a contact board with a second electrical contact disposed thereon; a second rivet; a temperature adjusting screw; a washer; and a control shaft; wherein:
the upper side of the heat-conductive guide is connected with the lower side of the top board through the first rivet;
the lower side of the heat-conductive guide is connected with the double-metal plate through the first rivet;
the long spring plate and the contact board are connected with the lower side of the top board through the second rivet;
the temperature adjusting screw, the washer, and the control shaft are sequentially from up to down installed on the upper side of the top board;
the first electrical contact and the second electrical contact are silver point contacts; and
the double-metal plate is configured to sense a temperature of the heat-conductive guide and actuate the short spring plate accordingly so that the first electrical contact is physically and electrically connected with the second electrical contact when the temperature sensed reaches a target temperature.

14. The thermostat of claim 13, wherein the temperature adjusting screw is configured to adjust and set the target temperature, and the washer is engaged with the temperature adjusting screw and configured to fix the setting of the target temperature.

15. The thermostat of claim 13 further comprising a first ceramic separator disposed between an assembly of the long spring plate and the short spring plate and the double-metal plate, wherein the double-metal plate is configured to actuate the short spring plate through the first ceramic separator.

16. The thermostat of claim 15 further comprising a second ceramic separator disposed between the top board and the short spring plate, wherein the temperature adjusting screw is configured to actuate the short spring plate through the second ceramic separator.

17. A thermostat comprising:
a heat-conductive guide with an upper side and a lower side; a top board with an upper side and a lower side; a double-metal plate; a first rivet; a short spring plate with a first electrical contact disposed thereon; a long spring plate being connected with the short spring plate; a contact board with a second electrical contact disposed thereon; a second rivet; a temperature adjusting screw; a washer; a control shaft; a first ceramic ring; a first lug; a second ceramic ring; a second lug; a third ceramic ring; and a ceramic guide; wherein:
the upper side of the heat-conductive guide is connected with the lower side of the top board through the first rivet;
the lower side of the heat-conductive guide is connected with the double-metal plate through the first rivet;
the long spring plate and the contact board are connected with the lower side of the top board through the second rivet;
the temperature adjusting screw, the washer, and the control shaft are sequentially from up to down installed on the upper side of the top board;
the first ceramic ring, the first lug, the long spring plate, the second ceramic ring, the contact board, the second lug, the third ceramic ring, and the ceramic guide are connected to the lower side of the top board through the second rivet sequentially from up to down; and
the double-metal plate is configured to sense a temperature of the heat-conductive guide and actuate the short spring plate accordingly so that the first electrical contact is physically and electrically connected with the second electrical contact when the temperature sensed reaches a target temperature.

18. The thermostat of claim 17 further comprising a first ceramic separator disposed between an assembly of the long spring plate and the short spring plate and the double-metal plate, wherein the double-metal plate is configured to actuate the short spring plate through the first ceramic separator.

19. The thermostat of claim 18 further comprising a second ceramic separator disposed between the top board and the short spring plate, wherein the temperature adjusting screw is configured to actuate the short spring plate through the second ceramic separator.

20. The thermostat of claim 19, wherein the control shaft is configured to be controlled by the temperature adjusting screw and pull or release the second ceramic separator so that the assembly of the long spring plate and the short spring plate is pulled or released, and when the short spring plate is released, the first electrical contact is physically and electrically connected with the second electrical contact.
